(19) United States
(12) Patent Application Publication
(10) Pub. No.: US 2007/0158408 A1
(43) Pub. Date: Jul. 12, 2007

(54) PORTABLE STORAGE DEVICE WITH IDENTIFYING FUNCTION

(75) Inventors: Chih-Ling Wang, TAIPEI (TW); Horace Chen, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., Hsinchu Hsien (TW)

(21) Appl. No.: 11/306,337

(22) Filed: Dec. 23, 2005

(51) Int. Cl. G06K 5/00; G06K 19/06

(52) U.S. Cl. 235/380; 235/492

(57) ABSTRACT

A portable storage device with identifying function is provided. The portable storage device comprises a data transmission interface, for electrically connecting to a host end; a memory transmission interface; a microcontroller, having a smart card engine and electrically connected to the data transmission interface and the memory transmission interface respectively; and a memory, having a personal identification number (PIN) stored therein and electrically connected to the memory transmission interface.

### BACKGROUND OF THE INVENTION

1. Field of the Invention

The present invention generally relates to a portable storage device with identifying function, and more particularly to a portable storage device with identifying function requiring a personal identification number (PIN) at first use to exclude any unauthorized user.

2. Description of Related Art

Following rapid advancement of computer technology, the computer, the cellular phone, the portable disk and the digital camera are very popular nowadays and changed people's life style according to the functions and the convenience provided by these electronic devices. Latest electronic products use storage devices, such as shock-proof, nonvolatile, high density storage device and the like, to save data. Among many portable devices, flash memory has advantageously replaced EEPROM. Because the semiconductor technology is mature, it is possible to promote both storage capacity and transmission speed of the flash memory. Thus, flash memory has gradually replaced the conventional storage media, such as a hard disk driver.

Due to progressive development of the flash memory, the portable disk comprising flash memory has become a multi-media electronic device. Such electronic device can be lighter, thinner, shorter and smaller. However, a user may easily misplace them and accidentally lose important data stored therein which may get into the hands of unauthorized persons. Furthermore, the computer software system usually requires the user to input the serial number or the register number to verify the user's legality in order to reduce the software piracy.

Therefore, it would be desirable to adopt the security of inputting the serial number or the register number into the portable storage device for verifying the user's legality.

### SUMMARY OF THE INVENTION

According to the aspect of the present invention, the portable storage device comprises a personal identification number (PIN). A user must input a PIN into the portable storage device at the time of first use and the inputted PIN should match with the PIN record stored in the portable storage device to enable the user to operate the portable storage device.

### BRIEF DESCRIPTION OF THE DRAWING

FIG. 1 is a block diagram of a portable storage device according to an embodiment of the present invention.

FIG. 2 is a flowchart of an operation procedure of a portable storage device according to an embodiment of the present invention.

FIG. 3 is a block diagram of a portable storage according to another embodiment of the present invention.

### DETAIL DESCRIPTION OF THE EMBODIMENTS

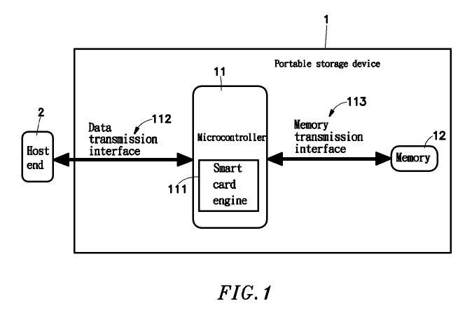

Referring to FIG. 1, a portable storage device 1 comprises a microcontroller 11 and a memory 12.

The microcontroller 111 comprises a smart card engine 111 and is electrically connected to a data transmission interface 112 and a memory transmission interface 113 respectively. The data transmission interface 112 is adopted for electrically connecting to a host end 2.

The memory 12 is electrically connected to the memory transmission interface 113 of the microcontroller 11 and comprises a personal identification number (PIN) stored therein.

When the portable storage device 1 is electrically connected to the host end 2 for the first time, and the host end 2 is initiated for processing data storage/retrieval actions or programs execution to the memory 12 of the portable storage device 1, the microcontroller 111 of the portable storage device 1 will ask a user to input a PIN via the host end 2. The inputted PIN is then transmitted to the smart card engine 111 via the data transmission interface 112. Thereafter, the smart card engine 111 compares the inputted PIN with a PIN record stored in the memory 12, wherein when the inputted PIN mismatches with the PIN record stored in the memory 12, the microcontroller 11 rejects the host end 2 from processing data storage/retrieval to the memory 12, and wherein when the inputted PIN matches with the PIN record in the memory 12, the host end 2 is allowed to operate the portable storage device 1, for example to process data storage/retrieval or programs execution, and the like.

Alternatively, the PIN, for identifying the user's identity, can also be stored in the microcontroller 11, and when the portable storage device 1 is electrically connected to the host end 2 for the first time, the microcontroller 11 of the portable storage device 1 will ask a user to input a PIN via the host end 2. The inputted PIN is then transmitted to the smart card engine 111 via the data transmission interface 112. Next, the smart card engine 111 compares the inputted PIN with a PIN record stored in the microcontroller 11, wherein when the inputted PIN mismatches with the PIN record stored in the microcontroller 11, the microcontroller 11 rejects the host end 2 from processing data storage/retrieval to the memory 12, and wherein when the inputted PIN matches with the PIN record stored in the microcontroller 11, the host end 2 is allowed to operate the portable storage device 1, for example to process data storage/retrieval or programs execution, and the like.

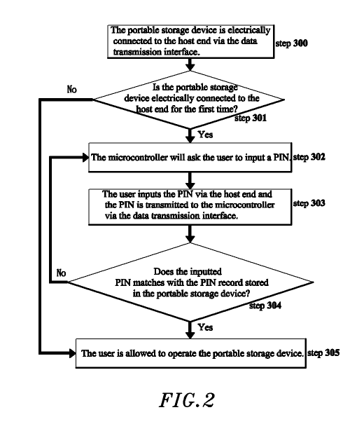

Hereinafter, the operation procedure of the portable storage device 1 is described with reference to FIG. 2 as follows.

At step 300, the portable storage device 1 is electrically connected to the host end 2 via the data transmission interface 112.

At step 301, the microcontroller 11 determines whether the portable storage device 1 is electrically connected to the host end 2 for the first time, if yes, the procedure proceeds to step 302, otherwise the procedure proceeds to step 305.

At step 302, the microcontroller 11 will ask a user to input a PIN.

At step 303, the user inputs the PIN via the host end 2 and the PIN is transmitted to the microcontroller 11 via the data transmission interface 112.

At step 304, the microcontroller 11 uses the smart card engine 111 to compare the inputted PIN with a PIN record stored in the portable storage device 1, wherein if the two PINs match, the procedure proceeds to step 305, otherwise, the procedure returns to step 302.

At step 305, the user is allowed to operate the portable storage device 1.

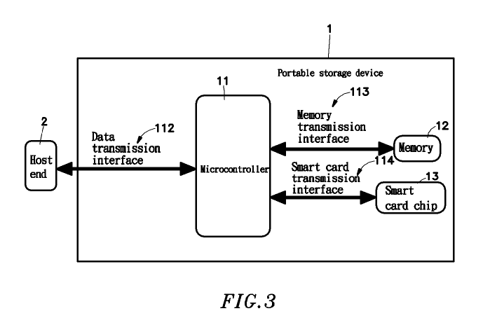

Referring to FIG. 3, a portable storage device 1 comprises the microcontroller 11, the memory 12 and a smart card chip 13.

The microcontroller 11 is electrically connected to a data transmission interface 112, a memory transmission interface 113 and a smart card transmission interface 114 respectively. The data transmission interface 112 is adopted for electrically connecting to a host end 2.

The memory 12 is electrically connected to the memory transmission interface 113 of the microcontroller 11.

The smart card chip 13 is electrically connected to the smart card transmission interface 114 of the microcontroller 111 and comprises a personal identification number (PIN) stored therein. The smart card chip 13 is adopted for encrypting/decrypting data stored in the portable storage device 1.

When the portable storage device 1 is electrically connected to the host end 2 for the first time, and the host end 2 is initiated to process data storage/retrieval or programs execution to the portable storage device 1, the microcontroller 11 of the portable storage device 1 will ask a user to input a PIN via the host end 2. The inputted PIN is then transmitted to the smart card chip 13 via the data transmission interface 112. Next, the smart card chip 13 compares the inputted PIN with a PIN record stored in the smart card IC 13, wherein when the inputted PIN matches with the PIN record in the smart card chip 13, the host end 2 is allowed operate the portable storage device 1, for example, to process data storage/retrieval or programs execution to the memory 12 of the portable storage device 1. As the host end 2 starts to process data storage to the memory 12, the smart card chip 13 encrypts the data and stores the encrypted data into the memory 12. Furthermore, the smart card chip 13 is adopted for not only encrypting/decrypting the data but also for processing mathematical calculation to enable the user to shop, add value and verify the identity on the Internet.

The aforementioned memory 12 may be a flash memory, a hard disk or an electrically erasable programmable read only memory (EEPROM), and it should be understood that they are only used for describing an embodiment of the memory 12 and is not intended for limiting the scope of the present invention. The encrypting/decrypting method of the smart card chip 13 may be an advanced encryption standard, a data encryption stand, a rivest shamir adleman encryption (RSA) or a triple data encryption algorithm, and it should be understood that they are only used for describing an embodiment of the encrypting/decrypting method of the smart card chip 13 and is not intended for limiting the scope of the present invention.

Furthermore, the abovementioned data transmission interface 112 may be connected to the host end 2 via wired or wireless connection. The wired connection may be a universal serial bus (USB) transmission interface, a serial advanced technology attachment (SATA) transmission interface, a personal computer memory card international association (PCMCIA) transmission interface or an institute of electrical and electronic engineers (IEEE1394) transmission interface. The wireless connection may be an infrared transmission, a wireless 802.15 ZigBee, a wireless 802.11a/b/g or a UWB. The above examples are merely used for illustrating the embodiment of connection of the portable storage device 1 to the host end 2, and are not intended for limiting the scope of the present invention.

Accordingly, the portable storage device 1 of the present invention has at least the following advantages.

1. It is required to input a PIN when the portable storage device 1 of the present invention is connected the host end 2, wherein the inputted PIN is compared with the PIN record stored in the portable storage device 1, and when the two PINs match, the user is allowed to operate the portable storage device 1.

2. The smart card chip 13 is adopted for encrypting/decrypting the data or programs stored in the portable storage device 1 of the present invention and for the mathematical calculations for allowing the user to add value and identity verification for secured shopping on the Internet via the host end 2.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A portable storage device with identifying function, comprising:
a data transmission interface, for electrically connecting to a host end;
a memory transmission interface;
a microcontroller, comprising a smart card engine and electrically connected to said data transmission interface and said memory transmission interface respectively; and
a memory, comprising a personal identification number (PIN) stored therein and electrically connected to said memory transmission interface.

2. The portable storage device with identifying function as claimed in claim 1, wherein said data transmission interface may be a wired connection.

3. The portable storage device with identifying function as claimed in claim 1, wherein said data transmission interface may be a wireless connection.

4. The portable storage device with identifying function as claimed in claim 1, wherein said memory comprises a flash memory, a hard disk or an EEPROM.

5. The portable storage device with identifying function as claimed in claim 2, wherein said wired connection is a USB transmission interface, a SATA transmission interface, a PCMCIA transmission interface or an IEEE1394 transmission interface.

6. The portable storage device with identifying function as claimed in claim 3, wherein said wireless connection is an Infrared transmission, a wireless 802.15 ZigBee, a wireless 802.11a/b/g or UWB.

7. A portable storage device with identifying function, comprising:
a data transmission interface, for electrically connecting to a host end;
a memory transmission interface;
a microcontroller, comprising a smart card engine and electrically connected to said data transmission interface and said memory transmission interface respectively, wherein said microcontroller comprises a personal identification number (PIN) stored therein; and
a memory, electrically connected to said memory transmission interface.

8. The portable storage device with identifying function as claimed in claim 7, wherein said data transmission interface may be a wired connection.

9. The portable storage device with identifying function as claimed in claim 7, wherein said data transmission interface may be a wireless connection.

10. The portable storage device with identifying function as claimed in claim 7, wherein said memory comprises a flash memory, a hard disk or an EEPROM.

11. The portable storage device with identifying function as claimed in claim 8, wherein said wired connection is a USB transmission interface, a SATA transmission interface, a PCMCIA transmission interface or an IEEE1394 transmission interface.

12. The portable storage device with identifying function as claimed in claim 9, wherein said wireless connection is an Infrared transmission, a wireless 802.15 ZigBee, a wireless 803.11 a/b/g or UWB.

13. A portable storage device with identifying function, comprising:
a data transmission interface, for electrically connecting to a host end;
a smart card transmission interface;
a memory transmission interface;
a smart card chip, electrically connected to said smart card transmission interface and comprising a personal identification number (PIN) stored therein, wherein said smart card chip is adopted for encrypting/decrypting data stored in said portable storage device;
a microcontroller, electrically connected to said data transmission interface, said smart card transmission interface and said memory transmission interface respectively; and
a memory, electrically connected to said memory transmission interface.

14. The portable storage device with identifying function as claimed in claim 13, wherein said data transmission interface may be a wired connection.

15. The portable storage device with identifying function as claimed in claim 13, wherein said data transmission interface may be a wireless connection.

16. The portable storage device with identifying function as claimed in claims 13, wherein said memory comprises a flash memory, a hard disk or an EEPROM.

17. The portable storage device with identifying function as claimed in claim 14, wherein said wired connection is a USB transmission interface, a SATA transmission interface, a PCMCIA transmission interface or an IEEE1394 transmission interface.

18. The portable storage device with identifying function claimed in claim 15, wherein said wireless connection is an infrared transmission, a wireless 802.15 ZigBee, a wireless 802.11a/b/g or a UWB.
